(19) United States
(12) Patent Application Publication
(10) Pub. No.: US 2012/0266983 A1
(43) Pub. Date: Oct. 25, 2012

(54) FAUCET DEVICE WITH TOUCH CONTROL AND DISPLAY CAPABILITIES

(75) Inventors: SHIH-CHIEH TSAI, CHANGHUA COUNTY (TW); TSAIR-RONG CHEN, HSINCHU COUNTY (TW); SHIH-CHANG CHEN, HSINCHU COUNTY (TW); CHUN-LUNG CHIU, HSINCHU COUNTY (TW); CHE-WEI HSU, HSINCHU COUNTY (TW)

(73) Assignee: CASHIDO CORPORATION, HSINCHU COUNTY (TW)

(21) Appl. No.: 13/093,185

(22) Filed: Apr. 25, 2011

(51) Int. Cl. F16K 51/00

(52) U.S. Cl. 137/560

(57) ABSTRACT

The present disclosure is related to a faucet device with touch control and display capabilities. The faucet device includes a gas providing unit, a faucet body, and a touch control and display system, wherein the faucet body and the touch control and display system are both coupled to the gas providing unit. The gas providing unit is for providing a predetermined gas to the faucet body, so as to enable the mixing of the predetermined gas with a water flow. The faucet body is equipped with a Venturi tube allowing for the predetermined gas to be transmitted automatically from the gas providing unit to the faucet body when the faucet body is turned on. The predetermined gas may not be transmitted to the faucet body when the water flow does not pass through the Venturi tube.

### BACKGROUND OF THE INVENTION

1. Field of the Invention

The present invention relates to a faucet device; in particular, to a faucet device with touch control and display capabilities.

2. Description of Related Art

Rapid industrial development inevitably comes with severe pollutions, such as water pollution, soil pollution, and air pollution. For minimizing the impact of the water pollution, many approaches to cleaning and sterilizing water for water outlet devices such as faucet, drinking fountain, spa, or bathtub have been introduced. Distillation, precipitation, filtering, solarization, and sterilization by ozone (O₃) are applied for cleaning and sterilizing the water as ozone is unstable in characteristic and tends to combine with other particles including pollutants. Therefore, the pollutants such as hazardous materials or microorganism could be excluded from the water as they have been in combination with the ozone.

The traditional water outlet device, however, generally lacks a mechanism of controlling delivery of a predetermined gas such as the ozone to the water. Therefore, it may be inconvenient for the water outlet device to activate or deactivate the delivery of the predetermined gas to the water.

### SUMMARY OF THE INVENTION

The object of the present invention is to provide a faucet device, especially a faucet device with touch control, display, and sterilization capabilities. Thus, faucet device may turn on/off the delivery of the predetermined gas in a more efficient and prompt manner.

In order to achieve the aforementioned objects, according to an embodiment of the present invention, a faucet device with touch control and display capabilities is provided. The faucet device with touch control and display capabilities includes a faucet body, a touch control and display system, and a gas providing unit. The touch control and display system is disposed on the faucet body, and the gas providing unit is coupled to the faucet body and the touch control and display system. The faucet body receives water flow transmitted from a water source, and outputs the water flow. The touch control and display system further includes a touch control module, display module, and a processing circuit. The touch control module generates a touch control signal. The display module is used to display configuration information. The gas providing unit is controlled by the touch control and display system through the received touch control signal, in order to determine whether to cause the gas providing unit to provide the predetermined gas with the faucet body.

It is worth mentioning that the touch control and display of the touch control and display system can be integrated into one module or disposed be in separately modules. Besides, the faucet body further includes a Venturi tube coupled to the gas providing unit, in order to retrieve the predetermined gas from the gas providing unit.

In order to further the understanding regarding the present invention, the following embodiments are provided along with illustrations to facilitate the disclosure of the present invention.

### BRIEF DESCRIPTION OF THE DRAWINGS

FIG. 1 shows a block diagram of a faucet device with touch control and display capabilities according to an embodiment of the present invention;

FIG. 2 shows a block diagram of a faucet device with touch control and display capabilities according to another embodiment of the present invention;

FIG. 3 shows a schematic diagram of a typical Venturi tube;

FIG. 4A shows a schematic diagram of a faucet device with touch control and display capabilities according to an embodiment of the present invention;

FIG. 4B shows an internal block diagram of a faucet device with touch control and display capabilities according to an embodiment of the present invention;

FIG. 4C shows a schematic diagram of a touch control and display system according to an embodiment of the present invention;

FIG. 5 shows an explosion diagram of a faucet body according to an embodiment of the present invention;

FIG. 6 shows an assembly drawing of a faucet body according to an embodiment of the present invention;

FIG. 7 shows a cross-section diagram of a faucet body according to an embodiment of the present invention;

FIG. 8 shows a schematic diagram of the water flow and the gas flow of a faucet body according to an embodiment of the present invention; and

FIG. 9 shows a schematic diagram of the backflow prevention mechanism when a water outlet of a faucet device is blocked according to one embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

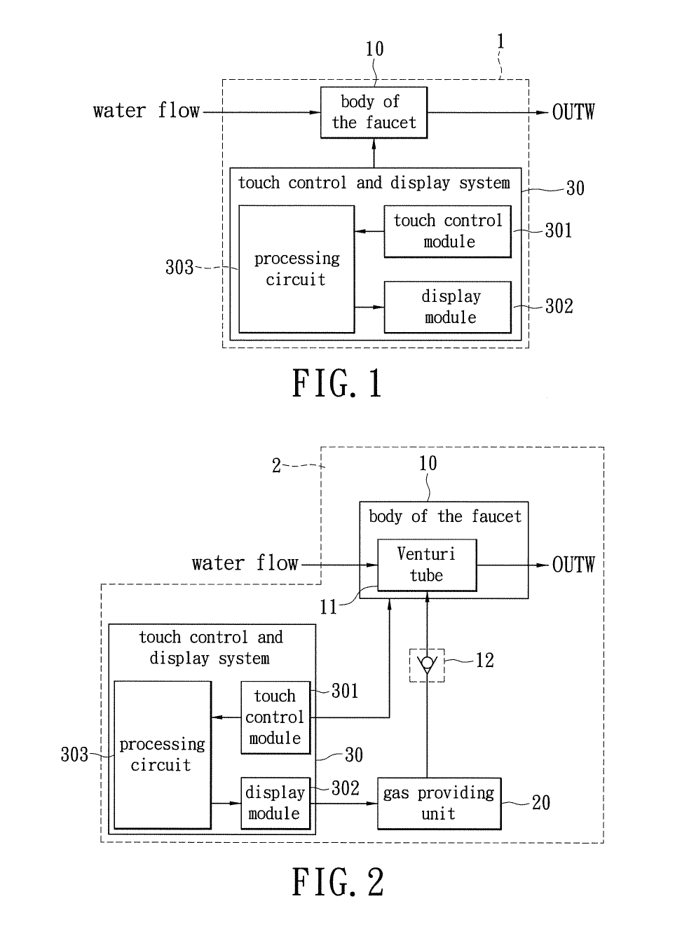

Please refer to FIG. 1 showing a block diagram of a faucet device with touch control and display capabilities according to an embodiment of the present invention. The faucet device with touch control and display capabilities 1 may be equipment that is capable of outputting a water flow. The equipment may include SPA bathtub, drinking fountain, water or sprinkler. The faucet device with touch control and display capabilities 1 includes a faucet body 10 and a touch control and display system 30. The touch control and display system 30 further includes a touch control module 301, a display module 302, and a processing circuit 303. The touch control and display system 30 may be disposed on the faucet body 10, and the processing circuit 303 is coupled to the touch control module 301 and the display module 302.

The faucet body 10 is configured to receive the water flow from a water source (not shown in the figure) and generate an outputted water flow OUTW. The faucet body 10 may further include an instruction unit (not shown in the figure). The instruction unit may include a LED (Light Emitting Diode) module and a temperature detecting module. The temperature detecting module is used to detect the temperature of the outputted water flow OUTW. The LED module may emit light with different colors to be indicative of different temperatures of the outputted water flow OUTW.

The touch control module 301 of the touch control and display system 30 may be a touch control device, such as a touch panel. The touch control module 301 generates a touch control signal to turn on or turn off the faucet body 10 and controls operations of related equipments such as ozone generator, reverse osmosis water filter, or de-chlorination filter core. Besides, the display module 302 of the touch control and display system 30 may display configuration information such as displaying the selection of turning on or turning off the faucet device with touch control and display capabilities 1 and other related equipments in terms of texts and/or graphics. The configuration information displayed by the display module 302 may include information of the temperature of the outputted water flow OTUW. Furthermore, the configuration information may be represented in texts/graphics/videos/audios. The processing circuit 303 may be implemented by a processing unit, such as a microprocessor. The processing circuit 303 is configured to process the signal generated by the touch control module 301, and to control the display module 302 for the display of the configuration information.

It is worth mentioning that the touch control and display system 30 and the faucet body 10 may be separately disposed. Meanwhile, the touch control module 301 and the display module 302 may be integrated together in one module, or be separately disposed.

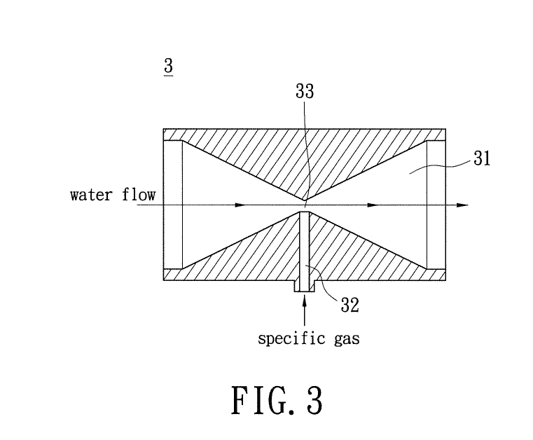

Please refer to FIG. 2 showing a block diagram of a faucet device with touch control and display capabilities according to another embodiment of the present invention. The embodiment in FIG. 2 is significantly identical to the embodiment shown in FIG. 1 except for differences specified in the follows. For example, a faucet device with touch control and display capabilities 2 in FIG. 2 further includes a backflow prevention unit 12 and a gas providing unit 20, and the faucet body 10 further includes a Venturi tube 11. The gas providing unit 20 is coupled to the faucet body 10 and the touch control and display system 30. The backflow prevention unit 12 is coupled between the faucet body 10 and the gas providing unit 20 with the backflow prevention unit 12 coupled between the Venturi tube 11 and the gas providing unit 20. In another implementation, the backflow prevention unit 12 may be disposed in the faucet body 10.

The gas providing unit 20 provides a predetermined gas to the faucet body 10. The gas providing unit 20 may generate or store the predetermined gas. After receiving the predetermined gas, the faucet body 10 may mix the predetermined gas and the water flow, and transmit the outputted water flow OUTW which may have been mixed with the predetermined gas. The predetermined gas may be the gas with capabilities of disinfection, sterilization, or deodorization, such as ozone, chlorine, chlorine dioxide, or other gases with high oxidizing ability which can be used to disinfect and clean. After being mixed with the water flow and the predetermined gas, the hazardous microorganism or material in the predetermined water flow may be removed.

The touch control and display system 30 may generate the touch control signal to control the gas providing unit 20 to provide the predetermined gas to the faucet body 10. The backflow prevention unit 12 is used to prevent the water flow which passes through the faucet body 10 from flowing back to the gas providing unit 20 so that any incidental or consequential damages to the gas providing unit 20 as the backflow of the water flow may be avoided.

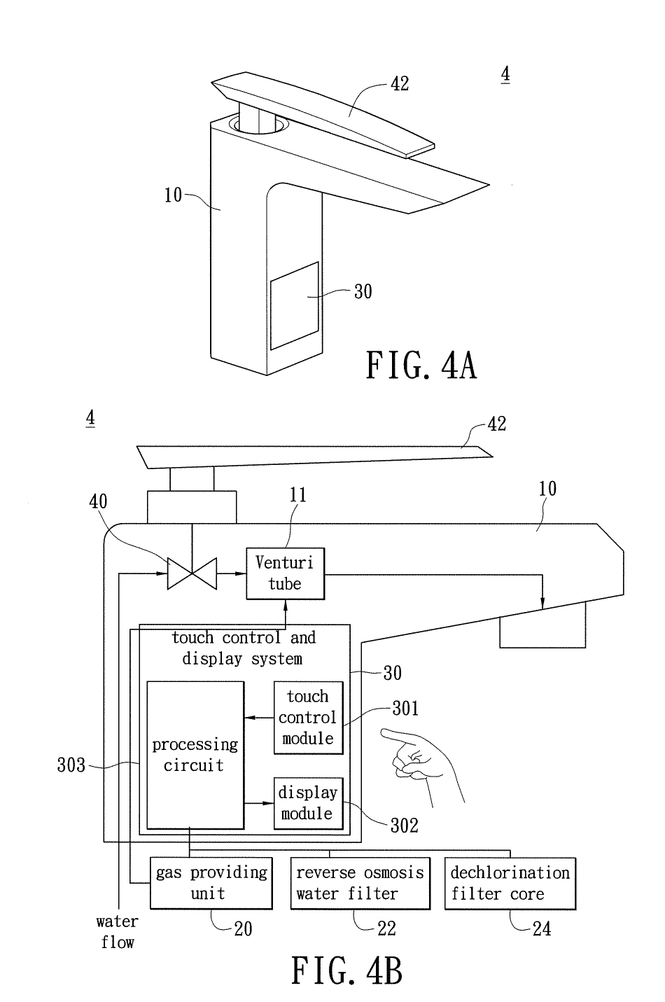

The Venturi tube 11 in the faucet body 10 utilizes Venturi effect to retrieve the predetermined gas from the gas providing unit 20 to the faucet body 10, causing the faucet body 10 to mix the predetermined gas and the water flow accordingly. Please refer to FIG. 3 showing a schematic diagram of a typical Venturi tube. The Venturi tube 3 has a double-funnel shaped water pathway 31 and a manifold 32. The manifold 32 laterally extends from a region of the water pathway 31 with a first cross-section. In one implementation, the first cross-section may be the smallest cross-section with respect to the water pathway 31. The Ventrui effect results in the fluid at a smaller cross-section of the pathway to flow quicker than the fluid flowing in another region of a larger cross-section. Because of the Bernoulli Effect, the pressure at the smaller cross-section of the pathway is lower than the pressure at counterpart of the larger cross-section. The variation of the fluid speed is balanced with the pressure of the fluid so as to be in compliance with law of conservation of energy.

Assume the pressure of the inputted water flow in the Ventrui tube 3 is one atmospheric pressure, the pressure of the inputted water flow would reduce to less than one atmospheric pressure, i.e. negative pressure, when the inputted water flow passes through a narrower region of the water pathway with the pressure outside the manifold 31 staying at one atmospheric pressure, causing the outside fluid (such as the predetermined gas in FIG. 2) to pour into the Venturi tube 3 through the manifold 32.

One embodiment of the present invention takes advantage of the Venturi effect to design the Ventrui tube 11 in the faucet body 10. The predetermined gas thus may be transmitted to the faucet body 10 automatically when the water flow passes through the faucet body 10. Transmission of the predetermined gas may not occur when no water flow passes through the faucet body 10. Accordingly, cost associated with additional device for the transmission of the predetermined gas such as a pump may be no longer necessary.

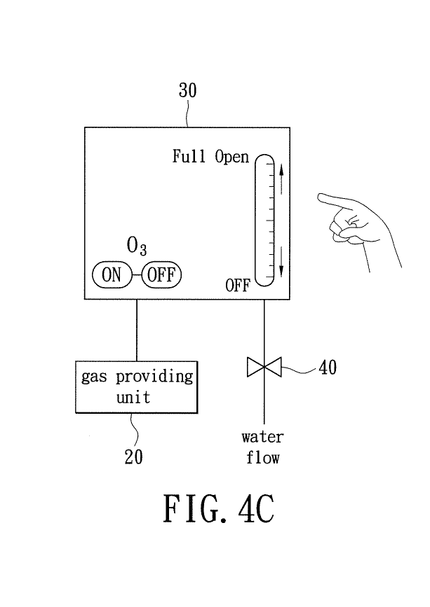

Please refer to FIG. 4A and FIG. 4B. FIG. 4A shows a schematic diagram of a faucet device with touch control and display capabilities according to an embodiment of the present invention. And FIG. 4B shows an internal block diagram of a faucet device with touch control and display capabilities according to an embodiment of the present invention. A faucet device 4 includes the faucet body 10, the touch control and display system 30, and the gas providing unit 30. The faucet body 10 comprises a valve core 40, a handle 42, and the Venturi tube 11. The touch control and display system 30 further includes a touch control module 301, a display module 302, and a processing circuit 303. The touch control and display system 30 may be disposed on the faucet body 10, and the gas supplying unit 20 is connected to the faucet body 10 through a gas pathway (not shown in FIG. 4A and FIG. 4B). The valve core 40 is connected to the water source (not shown in FIG. 4A and FIG. 4B).

The touch control and display system 30 generates the touch control signal, and controls the gas providing unit 20 to provide the predetermined gas according to the touch control signal. In one implementation, the touch control and display system 30 is used to control activation or deactivation of the gas providing unit 20, and the presence of the Venturi tube 11 helps facilitate the transmission of the predetermined gas to the faucet body 10. When the water flow passing through the Venturi tube 11 is associated with the negative pressure, the differential in the pressure helps transmit the predetermined gas to the faucet body 10, which is no longer the case when no water flow passes through the Venturi tube 11 resulting in no differential in the pressure between the space inside the Venturi tube 11 and the space outside thereof. When the gas supplying unit 20 of the faucet device 4 is activated, the predetermined gas supplied by the gas supplying unit 20 may be transmitted to the faucet body 10 through the gas pathway so long as the water flow is passing through the Venturi tube 11. And after being transmitted to the faucet body 10, the predetermined gas would be mixed with the water flow transmitted from the water source.

It is worth mentioning that the faucet body 10 according to this embodiment includes a handle 42, which is adapted to control the valve core 42 in order to shut (or not to shut) the water flow and control the flow rate of the water flow. Of course, in another implementation, a non-contact sensor may be used to control the shutting of the water flow and the flow rate thereof. The non-contact sensor may be an infrared ray sensor, an electric filed sensor, or other sensing equipment.

Although the touch control and display system 30 of the embodiments shown in FIG. 4A and FIG. 4B is disposed on the faucet body 10, the touch control and display system 30 may be separately disposed with respect to the faucet body 10 as previously mentioned. For example, the touch control and display system 30 may be placed upon a wall neighboring the faucet body 10 serving as an independent circuit module placed next to the faucet body 10.

Please refer to FIG. 4C showing a schematic diagram of a touch control and display system according to an embodiment of the present invention. As shown in FIG. 4C, activating (or deactivating) of the gas providing unit 20, causing the faucet body 10 to output the water flow and the flow rate thereof may be controlled by the touch control and display system 30. In this embodiment, the user can drag the scale icon for the water flow displayed by the touch control and display system 30 to control the valve core 40 for adjusting the flow rate and turn on (or turn off) the water flow.

Furthermore, the touch control and display system 30 may be connected to a reverse osmosis (RO) water filter 22 or a de-chlorination filter core 24. Therefore, the touch control and display module 30 may control activation/deactivation of the reverse osmosis water filter 22 or the de-chlorination filter core 24.

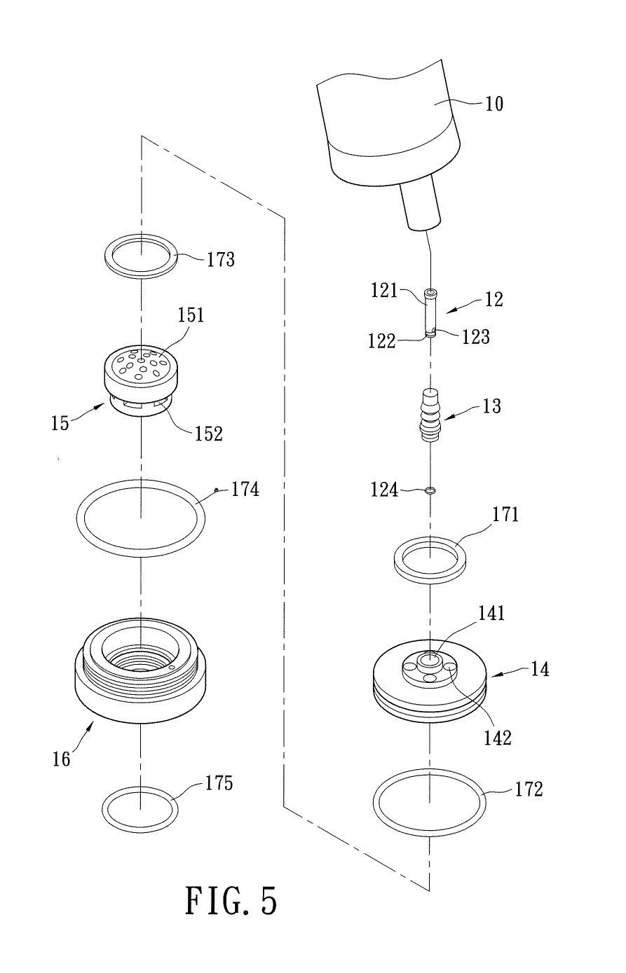

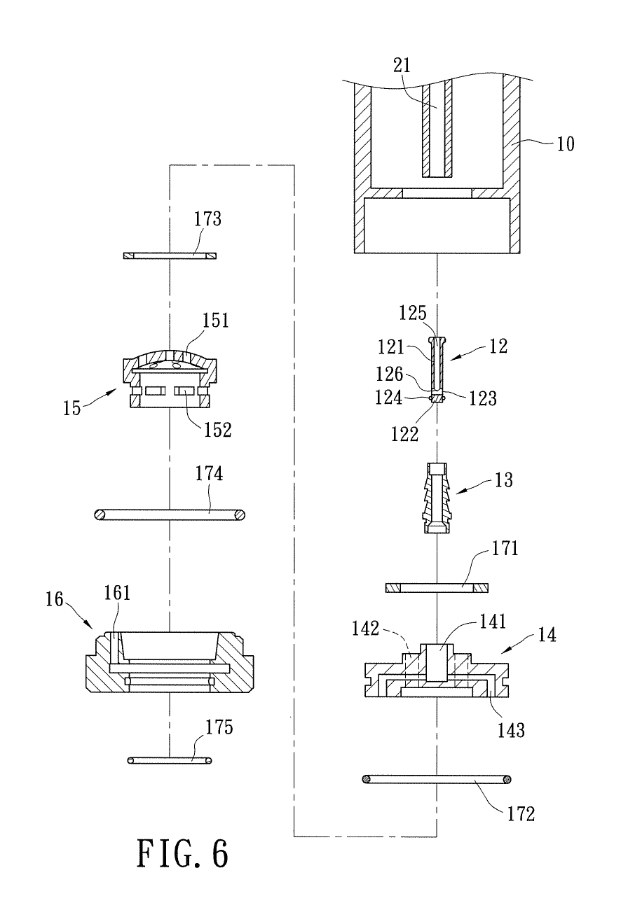

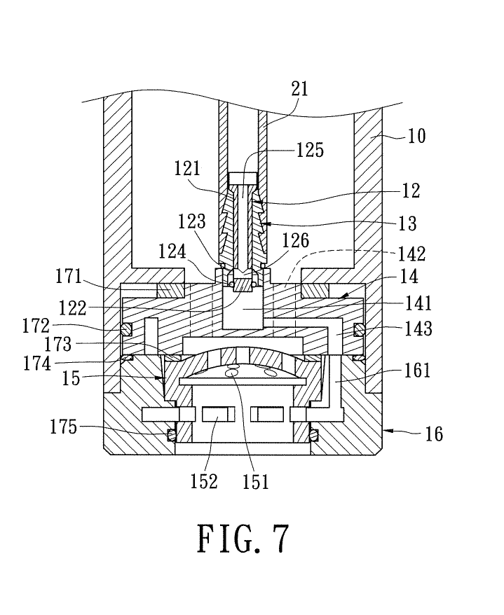

Please refer to FIGS. 5-7. FIG. 5 shows an explosion diagram of the faucet body 10 according to an embodiment of the present invention, FIG. 6, meanwhile, shows an assembly drawing of the faucet body 10 in FIG. 5, and FIG. 7 shows a cross-section diagram of the faucet body 10 in FIG. 6. The pathway 21 extends through the faucet body 10 to an output terminal of the faucet body 10 where the water flow is outputted. The faucet body 10 includes a backflow prevention unit 12, fastening section 13, drainage structure 14, aerator 15, water outlet 16, and the fastening rings 171-175. The backflow prevention unit 12 is slidingly engaged to the gas pathway 21 by the fastening section 13. An end of the gas pathway 21 where the predetermined gas is outputted is connected to the drainage structure 14, which is connected to the water outlet 16. The aerator 15 is disposed in an accommodating space between the drainage structure 14 and the water outlet 16. The fastening ring 171 is housed upon the drainage structure 14, the fastening ring 172 is placed in a trench in the middle of the drainage structure 14, the fastening ring 173 is disposed between the drainage structure 14 and the aerator 15, the fastening ring 174 is disposed between the drainage structure 14 and the water output 16, and the fastening ring 175 is adapted to surround the aerator 15.

The backflow prevention unit 12 includes a gas tube 121 and a backflow blocker 122. The gas tube 121 is slidingly engaged to the gas pathway 21 through the fastening section 13, and the gas tube 121 further includes a forward pathway 125 and a side pathway 126. The predetermined gas from the gas pathway 21 passes through the forward pathway 125 to a side pathway opening 123 of the side pathway 126. The backflow blocker 122 is disposed at a distal end of the gas tube 121 which is away from the gas supplying unit 20, i.e. the end of the gas tube 21 where the predetermined gas is outputted.

The drainage structure 14 includes gas holes 141 and 143 and a water hole 142, while the aerator 15 includes a mesh 151 and a gas input hole 152. And the water outlet 16 includes an air guiding hole 161. The gas hole 141 of the drainage structure 14 is connected to the gas pathway 21, and the water hole 142 is connected to the mesh 151 of the aerator 15. The air guiding hole 161 of the water outlet 16 is connected to the gas hole 143 of the drainage structure 14, and the gas input hole 152 of the aerator 15 is connected to the air guiding hole 161 of the water outlet 16.

Besides, the fastening rings 171, 172, and 173 are used for securing assembly, in order to prevent leakage of the water flow and the gas of the faucet body 10. The fastening ring 174 in one implementation is a water isolator plate of the faucet body 10 and the water outlet 16, and the fastening ring 175 is a water isolator plate for isolating the inner gas from an external environment.

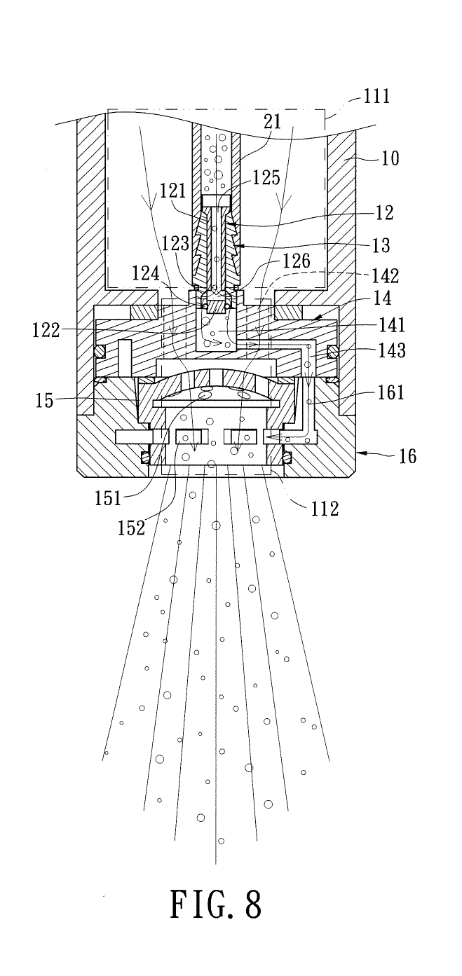

Please refer to FIG. 8 showing a schematic diagram of the water flow and the gas flow of a faucet body according to an embodiment of the present invention. When the faucet body 10 is turned on, the water flow that is received into the faucet body 10 may flow into the mesh 151 of the aerator 15 after passing through the water hole 142 before being outputted from the water outlet 16. When the function of providing the predetermined has been activated and the faucet body 10 is turned on, the predetermined gas transmitted from the gas providing unit 20 may pass through the gas pathway 21, the forward pathway 125 of the gas tube 121, the side pathway opening 123 of the side pathway 126, the gas holes 141 and 143, and the air guiding hole 161. The predetermined gas may flow into the aerator 15 from the gas input hole at a side surface of the aerator 15 before being mixed with the water flow. The gas holes 141 and 143, the air guiding hole 161, and the gas input hole 152 are used to guide the predetermined gas into a water-gas-mixing region of the aerator 15. Of course, when the user deactivates the function of gas providing of the faucet device through operating the touch control module 301 of the touch control and display system 30, the touch control module 301 may generate a corresponding touch control signal and transmit the same to the processing circuit 303. Accordingly, the gas providing unit 20 would stop providing the predetermined gas to the faucet body 10, regardless of whether the water flow passes through the Venturi tube 11 or not.

It is worth mentioning that the water pathway 111 and the water pathway 112 defined by the drainage structure 14, the aerator 15 and the water outlet 16 may be considered as a variety of the Venturi tube 11. A cross-section of the water pathway 111 of the faucet body 10 is larger than a cross-section of the water pathway 112, causing negative pressure to be present at the water pathway 112 of the narrower cross-section when water flow passes through the water pathway 111 and 112, the state of would occur. When the pressure of the predetermined gas in the gas providing unit 20 is larger than the pressure of the negative pressure, the predetermined gas may pass through the gas holes 141 and 143 and the air guiding hole 161 before being received within the aerator 15 via the gas input hole 152.

In other words, the space in the aerator 15 may be associated with the negative pressure when the faucet body 10 is turned on, which may serve as the water-gas-mixing region for the mixing of the water flow and the predetermined gas. Accordingly, the water flow outputted from the water outlet 16 may be full of bubbles of the predetermined gas. When the faucet body 10 is turned off, the negative pressure may no longer exist, causing no the predetermined gas to be entered into the aerator 15 as the pressure of the predetermined gas is not larger than the pressure of the water-gas-mixing region in the aerator 15.

According to the mentioned mechanism provided by the Venturi tube 11, the faucet device with touch control and display capabilities of the present invention does not need additional equipment, such as a gas pump, for pumping the predetermined gas to the faucet body 10. The exemplary Venturi tube 11 according to the present invention is for illustration. Other structure which can take advantage of the Venturi Effect may be applied to the present invention, too.

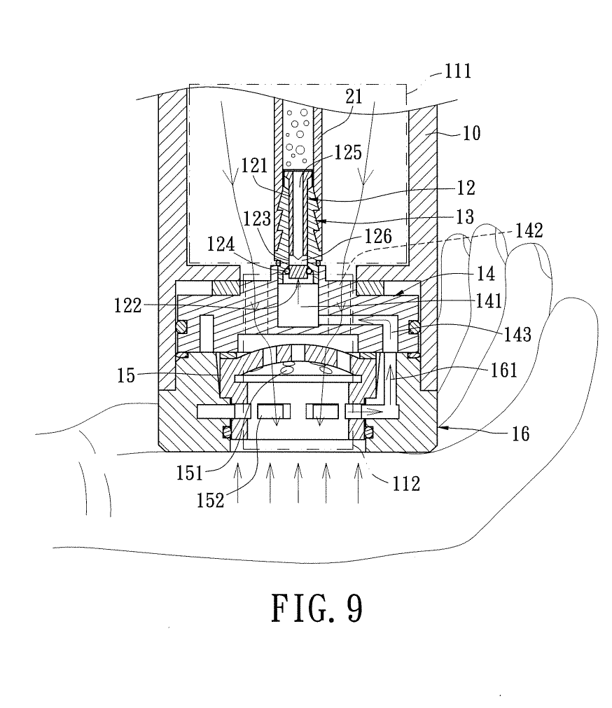

Please refer to FIG. 9 showing a schematic diagram of a backflow prevention mechanism when the water outlet 16 of the faucet device with touch control and display capabilities according to an embodiment of the present invention is blocked. When the water outlet 16 is blocked, the water flow may flow back to the gas providing unit 20 through the gas input hole 152, the air guiding hole 161, the gas holes 143 and 141 and the gas pathway 21. However, when the aforementioned backflow of the water flow encounters the backflow prevention unit 12, the backflow blocker 122 may be pushed up by the backflow, further moving up the gas tube 121 consequently and shutting the side pathway opening 123 of the side pathway 126. Accordingly, the gas pathway 21 may be shut, causing no backflow of the water flow to flow back to the gas providing unit 20 through the gas pathway 21. The backflow blocker 122 may be made by a material whose density is less than the density of the water flow, so that the backflow blocker 122 may be moved by the backflow of the water flow with ease. Besides, the backflow blocker 122 may be surrounded with the seal ring 121 for ensuring the gas pathway 21 to be airtight.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A faucet device with touch control and display capabilities, comprising:
a faucet body wherein the faucet body receives a water flow transmitted from a water source and outputs the water flow;
a touch control and display system disposed on the faucet body, comprising a touch control module, a display module, and a processing circuit coupled to the touch control module and the display module, wherein the touch control module generates a touch control signal when activated by touching, and the display module is configured to display a configuration information; and
a gas providing unit coupled to the faucet body and the touch control and display system, wherein the gas providing unit receives the touch control signal generated by the touch control module to determine whether to provide a predetermined gas to the faucet body;
wherein, the faucet body comprises a Venturi tube coupled to the gas providing unit for a receipt of the predetermined gas before transmitting the predetermined gas to the faucet body.

2. The faucet device with touch control and display capabilities according to claim 1, wherein the touch control and display system is further coupled to a reverse osmosis water filter or a de-chlorination filter core, in order to activate or deactivate the reverse osmosis water filter or the de-chlorination filter core according to the touch control signal.

3. The faucet device with touch control and display capabilities according to claim 1, wherein the predetermined gas is ozone.

4. The faucet device with touch control and display capabilities according to claim 1, wherein the Venturi tube comprises a water-gas-mixing region located at a predetermined position of a first cross-section and a gas input hole disposed at the water-gas-mixing region and coupled to the gas providing unit for receiving the predetermined gas.

5. The faucet device with touch control and display capabilities according to claim 4, wherein the water-gas-mixing region is associated with a negative pressure when the passes through the water-gas-mixing region and the negative pressure causes the predetermined gas to be received by the gas input hole so that the water flow is mixed with the predetermined gas.

6. The faucet device with touch control and display capabilities according to claim 1 further comprises a backflow prevention unit coupled between the gas providing unit and the faucet body to prevent the water flow which passes through the faucet body from flowing back to the gas providing unit.

7. The faucet device with touch control and display capabilities according to claim 6, wherein the backflow prevention unit is adapted to shut a gas pathway which is between the gas providing unit and the faucet body for transmitting the predetermined gas in order to prevent the water flow from passing through the gas pathway to the gas providing unit in an event of a backflow of the water flow.

8. The faucet device with touch control and display capabilities according to claim 7, wherein the backflow prevention unit further comprises:
a gas tube, slidingly engaged to the gas pathway, comprising a forward pathway and a side pathway, wherein the predetermined gas is transmitted through the forward pathway and the side pathway to the faucet body; and
a backflow blocker disposed at a distal end of the gas tube away from the gas providing unit, wherein in the event of the backflow of the water flow the backflow blocker is adapted to push the gas tube to seal the forward pathway and the side pathway, in order to shut the gas pathway.

9. The faucet device with touch control and display capabilities according to claim 8, wherein the backflow blocker is enclosed by a seal ring which is used to ensure the gas pathway to be airtight in the event of the backflow of the water flow.

10. The faucet device with touch control and display capabilities according to claim 8, wherein the backflow blocker is made by a material of a density less than a density of the water flow.

11. The faucet device with touch control and display capabilities according to claim 1, wherein the faucet body further comprises:
a drainage structure, coupled to a gas pathway which is used to transmit the predetermined gas from the gas supplying unit to the faucet body, comprising a water hole and a gas hole, wherein the gas hole is connected to the gas pathway; and
a water outlet, coupled to the drainage structure, comprising an air guiding hole connected to the gas hole.

12. The faucet device with touch control and display capabilities according to claim 11, wherein the faucet body further comprises an aerator disposed in an accommodating space between the drainage structure and the water outlet, wherein the aerator comprises a mesh, a gas input hole, and a water-gas-mixing region, wherein the mesh is connected to the water hole, and the air input hole is connected to the air guiding hole.

13. The faucet device with touch control and display capabilities according to claim 12, wherein the predetermined gas is input to the water-gas-mixing region through the gas pathway, the gas hole, and the air guiding hole, and the water flow is input to the water-gas-mixing region through the water hole and the mesh.

14. The faucet device with touch control and display capabilities according to claim 13, wherein the gas hole, the gas guiding hole and the air input hole are at a lateral side surface of the water pathway of the faucet body in order to guide the predetermined gas to the water-gas-mixing region.

15. The faucet device with touch control and display capabilities according to claim 1, wherein the configuration information displayed by the display module are texts, graphics, or videos/audios.

16. The faucet device with touch control and display capabilities according to claim 1, wherein the faucet body comprises an instruction unit which displays different visible lights to indicate a temperature of the water flow in the faucet body.

17. The faucet device with touch control and display capabilities according to claim 1, wherein whether the faucet device with touch control and display capabilities outputs the water flow and a rate of the outputted water flow are controlled by the touch control and display system, a handle, or a non-contact sensor.

18. The faucet device with touch control and display capabilities according to claim 17, wherein the non-contact sensor is an infrared ray sensor or an electric filed sensor.
